(19) United States
(12) Patent Application Publication
(10) Pub. No.: US 2026/0171491 A1
(43) Pub. Date: Jun. 18, 2026

(54) ELECTROLYTE COMPOSITION AND LITHIUM BATTERY

(71) Applicant: INDUSTRIAL TECHNOLOGY RESEARCH INSTITUTE, Hsinchu (TW)

(72) Inventors: Hsiu-Ling LAI, Hsinchu City (TW); Ting-Ju YEH, Taipei City (TW); Wei-Hsin WU, Hsinchu City (TW); Jheng-Jin LUO, Zhudong Town (TW); Fa-Hao TANG, Taoyuan City (TW); Shih-Chieh LIAO, Taoyuan City (TW); Jen-Chih LO, Hsinchu City (TW); Li-Chun CHEN, Keelung City (TW)

(73) Assignee: INDUSTRIAL TECHNOLOGY RESEARCH INSTITUTE, Hsinchu (TW)

(21) Appl. No.: 19/235,726

(22) Filed: Jun. 12, 2025

(30) Foreign Application Priority Data
Dec. 13, 2024 (TW) 113148587

(51) Int. Cl. H01M 10/0565; H01M 4/38; H01M 4/525; H01M 10/052; H01M 10/058; H01M 50/417

(52) U.S. Cl. CPC H01M 10/0565; H01M 4/382; H01M 4/525; H01M 10/052; H01M 10/058; H01M 50/417; H01M 2300/0085

(57) ABSTRACT

An electrolyte composition includes a solvent, a lithium salt, a diluent, a cationic ring-opening polymerization initiator, and a non-phosphorus polymer. The non-phosphorus polymer has repeating units represented by formula (I), wherein n=30-1200, and based on a total weight of the electrolyte composition being 100 wt %, the electrolyte composition includes 0.5-10 wt % of the non-phosphorus polymer.

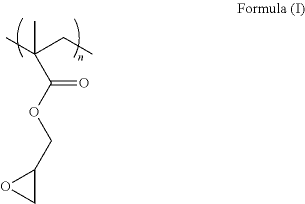

### CROSS REFERENCE TO RELATED APPLICATIONS

The present application is based on, and claims priority from, Taiwan Application Serial Number 113148587, filed on Dec. 13, 2024, the disclosure of which is hereby incorporated by reference herein in its entirety.

### TECHNICAL FIELD

The present disclosure relates to an electrolyte composition and a lithium battery.

### BACKGROUND

Lithium batteries are now the mainstream technology in commercial battery markets and are presently being developed to be thinner, lighter, shorter, and safer, and to have a higher energy density and a longer cycle life.

Liquid lithium batteries have safety problems such as liquid leakage, battery swelling, heating, and fuming. In addition, when a liquid lithium battery uses a lithium metal negative electrode, the highly active “lithium metal” therein may cause the electrolyte included in the lithium metal battery to decompose (i.e., undergo a reduction reaction) and form a passivation solid electrolyte layer (SEI). The passivation solid electrolyte layer may cause uneven lithium deposition and produce dendrites, which may lead to a short circuit, explosion, or fire in the lithium metal battery.

### SUMMARY

An embodiment of the present disclosure provides an electrolyte composition including a solvent, a lithium salt, a diluent, a cationic ring-opening polymerization initiator, and a non-phosphorus polymer. The non-phosphorus polymer has repeating units represented by formula (I):

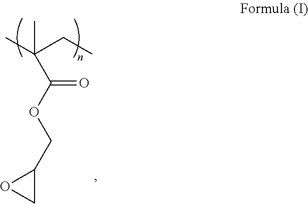

wherein n=30-1200. Based on a total weight of the electrolyte composition being 100 wt %, the electrolyte composition includes 0.5-10 wt % of the non-phosphorus polymer.

An embodiment of the present disclosure provides a lithium battery including a positive electrode, a negative electrode, and a semi-solid electrolyte. The negative electrode is disposed opposite to the positive electrode. The semi-solid electrolyte is disposed between the positive electrode and the negative electrode. The semi-solid electrolyte is formed by an electrolyte composition through a ring-opening polymerization process. The electrolyte composition includes a solvent, a lithium salt, a diluent, a cationic ring-opening polymerization initiator, and a non-phosphorus polymer. The non-phosphorus polymer has repeating units represented by formula (I):

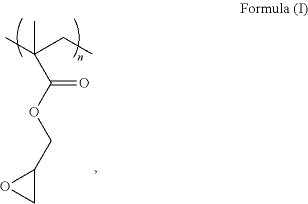

wherein n=30-1200. Based on a total weight of the electrolyte composition being 100 wt %, the electrolyte composition includes 0.5-10 wt % of the non-phosphorus polymer.

### BRIEF DESCRIPTION OF THE DRAWINGS

The present disclosure can be more fully understood by reading the subsequent detailed description and examples with references made to the accompanying drawings, wherein:

FIG. 1 is a schematic view of a lithium battery in accordance with an embodiment of the present disclosure;

FIGS. 2A to 2D are graphs showing a relationship between polarized voltage and cycles (within 10 times) of lithium metal batteries in accordance with examples of the present disclosure and comparative examples;

FIGS. 3A to 3D are graphs showing a relationship between polarized voltage and cycles (hundreds of times) of lithium metal batteries in accordance with examples of the present disclosure and comparative examples;

FIGS. 4A and 4B are electrochemical impedance spectroscopy (EIS) of lithium metal batteries in accordance with examples of the present disclosure and comparative examples;

FIG. 5 is a graph showing a relationship between current and potential of lithium metal batteries in accordance with an example of the present disclosure and a comparative example; and

FIG. 6 is a graph showing a relationship between capacity retention and cycles of lithium metal batteries in accordance with examples of the present disclosure and comparative examples.

### DETAILED DESCRIPTION

It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the singular forms “a,” “an,” and “the” are intended to include the plural forms as well, unless the context clearly indicates otherwise.

It will be understood that, although the terms “first,” “second,” etc., may be used herein to describe various steps, elements, components, regions, layers and/or sections, these steps, elements, components, regions, layers and/or sections should not be limited by these terms. These terms are used to distinguish one step, element, component, region, layer or section from another step, element, component, region, layer or section.

It will be understood that, the methods described herein include multiple steps, and additional operations can be provided before, during, and/or after the described steps. Some of the steps that are described can be replaced or eliminated for different embodiments. Although some embodiments are discussed with operations performed in a particular order, these operations may be performed in another logical order.

A specific numerical range values denoted by the expression “a to b” or “a-b” as used herein is defined as “≥a and ≤b”.

The term “non-phosphorus polymer having repeating units represented by formula (I)” as used herein refers to a polymer that includes the repeating units represented by formula (I) and other repeating units, but does not contain any phosphorus (P) atoms. In some embodiments, the term “non-phosphorus polymer having repeating units represented by formula (I)” as used herein refers to a polymer consisting of the repeating units represented by formula (I).

An embodiment of the present disclosure provides an electrolyte composition including a solvent, a lithium salt, a diluent, a cationic ring-opening polymerization initiator, and a non-phosphorus polymer having repeating units represented by formula (I):

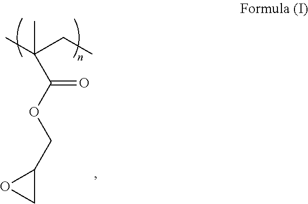

wherein n=30-1200. Based on a total weight of the electrolyte composition being 100 wt %, the electrolyte composition includes 0.5-10 wt % of the non-phosphorus polymer.

In some embodiments, the non-phosphorus polymer of the present disclosure may be an oligomer including repeating units represented by formula (I). In comparison with the phosphorus-containing polymers, with the same content ratio, the non-phosphorus polymer of the present disclosure has more curable units (epoxy groups), which may effectively cure the electrolyte without affecting the battery impedance. In some embodiments, the weight average molecular weight of the non-phosphorus polymer may be 5,000 to 200,000 g/mol, but the disclosure is not limited thereto. In some embodiments, the weight average molecular weight of the non-phosphorus polymer may be 10,000-150,000 g/mol, 20,000-100,000 g/mol, 30,000-75,000 g/mol, or 40,000-50,000 g/mol. In some embodiments, the non-phosphorus polymer merely contains the repeating units represented by formula (I). The non-phosphorus polymer of the present disclosure having the above characteristics may exhibit good electrochemical stability.

The non-phosphorus polymer having repeating units represented by formula (I) has C═O and an epoxy group. Therefore, the aforementioned non-phosphorus polymer will form oxyethylene ether groups after a ring-opening polymerization process. In some embodiments, the aforementioned non-phosphorus polymer may be ring-opened polymerized to form a network polymer. The network polymer may adsorb the lithium salt and solvent, thereby improving the safety of batteries including the same. In some embodiments, the temperature of the ring-opening polymerization process may be lower than 60° C., such as 20° C.-55° C., 20° C.-45° C., 20° C.-40° C., or 20° C.-35° C. In some embodiments, the network polymer may include an oxyethylene ether group and C═O. Both C═O and the oxyethylene ether group are easy to coordinate with the lithium salt in the electrolyte composition, which increases the lithium salt cation-anion pairs (Aggregate, AGG).

In some embodiments, the aforementioned network polymer may have repeating units represented by formula (II):

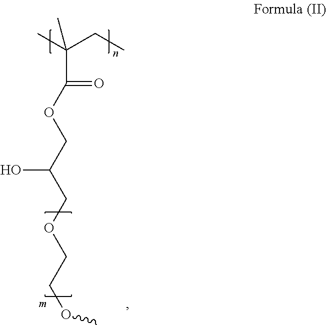

wherein n=30-1200 and m=1-5. In some embodiments, the weight average molecular weight of the network polymer may be >200,000 g/mol.

When the electrolyte composition includes 0.5-10 wt % of the non-phosphorus polymer based on the total weight of the electrolyte composition being 100 wt %, the lithium salt component included in the electrolyte composition may initiate a subsequent ring-opening polymerization reaction, so that the lithium salt, diluent and solvent are completely solidified into the semi-solid electrolyte, thereby improving the safety of the battery including the same. When the electrolyte composition includes too much of the non-phosphorus polymer (such as over 10 wt % of the non-phosphorus polymer based on the total weight of the electrolyte composition being 100 wt %), the semi-solid electrolyte obtained by the ring-opening polymerization process may have lower ionic conductivity and higher interfacial impedance. When the electrolyte composition includes too little of the non-phosphorus polymer (such as less than 0.5 wt % of the non-phosphorus polymer based on the total weight of the electrolyte composition being 100 wt %), the electrolyte composition may not be able to cure properly. In some embodiments, based on the total weight of the electrolyte composition being 100 wt %, the content of the non-phosphorus polymer in the electrolyte composition is 0.6 wt %-8 wt %, 0.7 wt %-6 wt %, 0.8 wt %-4 wt %, 0.9 wt %-3 wt %, or 1 wt %-2 wt %.

The cation of the cationic ring-opening polymerization initiator of the present disclosure may include Na⁺, Li⁺, K⁺, Ag⁺, or NH₄⁺. In some embodiments, the cationic ring-opening polymerization initiator of the present disclosure may include an ionic compound capable of dissociating to release a nucleophilic group or an amine compound. Examples of amine compounds may include primary amines including monofunctional R—NH₂ and difunctional NH₂—R—NH₂, wherein R is an alkyl group, an ethoxy group, a propoxy group, an alkylene group, or an ether chain, such as polyetheramine. Examples of the ionic compound capable of dissociating to release the nucleophilic group may include any ionic compound capable of dissociating to release the nucleophilic group including CH₃COO⁻, OH⁻, BF₄⁻, PF₆⁻, ClO₄⁻, TFSI⁻, AsF₆⁻, SbF₆⁻, or any combination thereof. In some embodiments, the cationic ring-opening polymerization initiator of the present disclosure may include lithium tetrafluoroborate. Lithium tetrafluoroborate may be used as lithium salt and reaction initiator in the electrolyte, and may easily react with trace amounts of water in the electrolyte to form BF₄(H₂O)⁻+Li⁺, inducing epoxy ring-opening polymerization.

Based on 100 parts by weight of the electrolyte composition, the electrolyte composition of the present disclosure may include 0.5 parts by weight to 5 parts by weight of the cationic ring-opening polymerization initiator. In some embodiments, based on 100 wt % of the electrolyte composition, the electrolyte composition of the present disclosure may include 0.1 wt %-5 wt %, 0.5 wt %-5 wt %, 0.1 wt %-4 wt %, 0.1 wt %-3 wt %, 0.1 wt %-2 wt %, or 0.1 wt %-1 wt % of the cationic ring-opening polymerization initiator.

The concentration of the lithium salt in the solvent may be about 0.5 M to 6 M, such as about 0.7 M, 0.8 M, 0.9 M, 1 M, 1.2 M, 1.3 M, 1.4 M, 1.5 M, 2 M, 3 M, 4 M, or 5 M. In some embodiments, the lithium salt may include at least one lithium salt compounds. In some embodiments, the lithium salt may include at least two different lithium salt compounds. In embodiments where the lithium salt includes at least two different lithium salt compounds, the different lithium salts have the same or different concentrations in the solvent. The weight ratio of the solvent to the lithium salt may be 60:40 to 90:10. In the embodiment where the lithium salt includes at least two different lithium salt compounds, the weight ratio of the solvent to the total of all lithium salts may be 60:40 to 90:10. In some embodiments, the molar ratio of all lithium salts to the solvent may be 1:2 to 1:10, such as 1:3 to 1:10, 1:4 to 1:9. In some embodiments, the lithium salt of the present disclosure may include lithium tetrafluoroborate (LiBF₄), lithium hexafluorophosphate (LiPF₆), lithium perchlorate (LiClO₄), lithium bis(trifluoromethanesulfonyl) imide (LiTFSI), lithium bis(fluorosulfonyl) imide (LiFSI), lithium hexafluoroarsenate (LiAsF₆), lithium hexafluoroantimonate (LiSbF₆), or any combination thereof, but the disclosure is not limited thereto. The lithium salt of the present disclosure may be the same as or different from the cationic ring-opening polymerization initiator. In some embodiments, the lithium salt may include lithium tetrafluoroborate, lithium hexafluorophosphate, lithium bis(fluorosulfonimide), lithium bis(trifluoromethanesulfonyl) imide, or any combination thereof.

In some embodiments, the solvent may include an ether compound, a carbonate compound, or a combination thereof. The solvent molecules may coordinate with the lithium salt cations to form cation-anion pairs. When the ether compound is used as solvent, the polarity of the electrolyte composition may be reduced and the lithium salt cation-anion pairs may be increased. The ether compound that may be used as solvent is not specifically limited, as long as it can dissolve the lithium salt, the cationic ring-opening polymerization initiator, and the non-phosphorus polymer and does not hinder the ring-opening polymerization process. In some embodiments, the ether compound may include dimethyl ether (DME), diethyl ether (DEE), 1,2-dimethoxypropane (DMP), or a combination thereof, but the present disclosure is not limited thereto. In some embodiments, the carbonate compound may include fluoroethylene carbonate (FEC), diethyl carbonate (DEC), dimethyl carbonate (DMC), or a combination thereof. In some embodiments, the solvent is the ether compound. In some embodiments, ether compounds are merely used as solvents.

In some embodiments, the volume ratio of the solvent to the diluent in the electrolyte composition may be 1:0.1-1. The diluent is soluble in the solvent but does not coordinate with the lithium salt, which may further increase the presence of cation-anion pairs, form more lithium-philic layers (such as containing LiF), and reduce the viscosity of the electrolyte composition to improve fluidity. In some embodiments, the volume ratio of the solvent to the diluent may be 1:0.15-0.8, 1:0.18-0.6, 1:0.2-0.4, or 1:0.22-0.3. In some embodiments, the molar ratio of the lithium salt to the diluent may be 1:0.1-0.9, such as 1:0.2-0.8. The type of diluent is not specifically limited, as long as it does not hinder the ring-opening polymerization process. In some embodiments, the diluent may include other ether compounds different from the solvent. In some embodiments, the diluent may include a perfluorinated ether compound. In some embodiments, the diluent may include 1,1,2,2-tetrafluoroethyl-2,2,3,3-tetrafluoropropyl ether (TTFE), bis(2,2,2-trifluoroethyl) ether 2,2,2-trifluoroethyl ether (BTFE), 1,2-bis(1,1,2,2-tetrafluoroethoxy) ethane (TFEE), or a combination thereof, but the disclosure is not limited thereto. In some embodiments, the diluent is the perfluorinated ether compound.

In some embodiments, the electrolyte composition is composed of the aforementioned solvent, lithium salt, cationic ring-opening polymerization initiator, and non-phosphorus polymer, and the non-phosphorus polymer merely contains the repeating unit represented by formula (I).

The electrolyte composition of the present disclosure may be used to prepare batteries. In some embodiments, the electrolyte composition of the present disclosure is in a liquid state before being injected into the battery cavity, and thus may be easily poured into the battery cavity. In some embodiments, the electrolyte composition of the present disclosure may be injected into the battery cavity after a lamination of a negative electrode, a positive electrode, and a separator being placed in the battery cavity. The battery may be formed after the electrolyte composition is converted into the semi-solid electrolyte through the ring-opening polymerization process. The formed semi-solid electrolyte includes a polymer with a three-dimensional network structure, which solidifies the lithium salt, diluent and solvent, and improves the safety of the battery without hindering the battery performance. Furthermore, the network polymer includes an oxyethylene ether group and C═O. Both C═O and the oxyethylene ether group are easy to coordinate with the lithium salt in the electrolyte composition, which increases the lithium salt cation-anion pairs (Aggregate, AGG). That is, the electrolyte composition of the present disclosure can achieve the desired battery characteristics with a relatively small amount used of polymer. In addition, in some embodiments, the battery including the semi-solid electrolyte formed by the electrolyte composition of the present disclosure also has the advantages of high electrochemical stability and/or slow impedance increase.

An embodiment of the present disclosure provides a lithium battery, including a semi-solid electrolyte, a positive electrode, and a negative electrode, wherein the semi-solid electrolyte is disposed between the positive electrode and the negative electrode. The aforementioned semi-solid electrolyte may be formed by curing the electrolyte composition through a ring-opening polymerization process. The lithium battery may further include a separator.

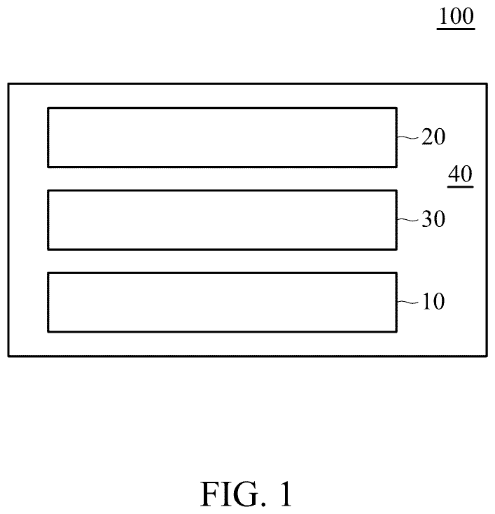

FIG. 1 is a schematic view of a lithium battery in accordance with an embodiment of the present disclosure. As shown in FIG. 1, the lithium battery 100 of the present disclosure includes a semi-solid electrolyte 40, a negative electrode 10, and a positive electrode 20. The semi-solid electrolyte 40 is disposed between the negative electrode 10 and the positive electrode 20, and the negative electrode 10 and the positive electrode 20 are opposite to each other. In some embodiments, the semi-solid electrolyte 40 is distributed throughout the battery 100. In some embodiments, the lithium battery 100 of the present disclosure further includes a separator 30 disposed in the semi-solid electrolyte 40 and disposed between the negative electrode 10 and the positive electrode 20, wherein the negative electrode 10 is opposite to the positive electrode 20 via the separator 30.

The negative electrode 10 may include a negative electrode active layer. The negative electrode active layer may include a negative electrode active material. In some embodiments, the negative electrode active material may include lithium metal and alloys thereof, transition metal oxide, metastable phase spherical carbon (MCMB), carbon nanotube (CNT), graphene, coke, artificial graphite, natural graphite, carbon black, carbon fiber, mesophase carbon microbead, glassy carbon, lithium-containing compound, silicon-containing compound, tin, tin-containing compound, or a combination thereof. Examples of the lithium-containing compound may include LiAl, LiMg, LiZn, Li₃Bi, Li₃Cd, Li₃Sb, Li₄Si, Li_{4.4}Pb, Li_{4.4}Sn, LiC₆, Li₃FeN₂, Li_{2.6}Co_{0.4}N, Li_{2.6}Cu_{0.4}N, or a combination thereof. Examples of the silicon-containing compound may include silicon oxide, carbon-modified silicon oxide, silicon carbide, pure-silicon material, or a combination thereof. Examples of the tin-containing compound may include tin antimony alloy (SnSb) and tin oxide (SnO). Examples of the transition metal oxide may include lithium titanium oxide (Li₄Ti₅Oi₂), niobium titanium oxide (TiNb₂O₇), or a combination thereof. Examples of the lithium alloy may include aluminum-lithium-containing alloy, lithium-magnesium-containing alloy, lithium-zinc-containing alloy, lithium-lead-containing alloy, or lithium-tin-containing alloy. In some embodiments, the negative electrode active material may include lithium metal and alloys thereof, artificial graphite, natural graphite, mesophase carbon microbead, silicon, silicon oxide, carbon-modified silicon oxide, lithium titanium oxide, niobium titanium oxide, or any combination thereof.

In some embodiments, the negative electrode active layer may be prepared from a negative electrode slurry. The negative electrode slurry may include the aforementioned negative electrode active material, conductive additive, binder, and solvent. The negative electrode active material, conductive additive and binder are dispersed in the solvent, and the solid content of the negative electrode slurry may be 40 wt % to 80 wt %. In some embodiments, in the negative electrode active layer, based on 100 wt % of the negative electrode slurry, the negative electrode slurry includes about 80 wt % to 99.8 wt % of the negative electrode active material, about 0.1 wt % to 10 wt % of the conductive additive, and about 0.1 wt % to 10 wt % of the binder.

Examples of the aforementioned conductive additive may include carbon black, conductive graphite, carbon nanotube, carbon fiber, graphene, or any combination thereof, but the present disclosure is not limited thereto.

Examples of the aforementioned binder may include polyvinyl alcohol, polytetrafluoroethylene, sodium carboxymethyl cellulose, polyvinylidene fluoride, polystyrene butadiene copolymer, fluorinated rubber, polyurethane, polyvinyl pyrrolidone, poly(ethyl acrylate), polyvinyl chloride, polyacrylonitrile, polybutadiene, polyacrylic acid, or any combination thereof, but the present disclosure is not limited thereto.

Examples of the aforementioned solvent may include N-methyl-2-pyrrolidone (NMP), N,N-dimethylformamide (DMF), N,N-dimethylacetamide (DMAc), pyrrolidone, N-dodecylpyrrolidone, γ-butyrolactone, water, or any combination thereof, but the present disclosure is not limited thereto.

In some embodiments, the negative electrode 10 may further include a negative electrode current-collecting layer. The negative electrode active layer may be disposed on the negative electrode current-collecting layer. In the embodiment where the lithium battery 100 further includes the separator 30, the negative electrode active layer may be disposed between the separator 30 and the negative electrode current-collecting layer. The negative electrode current-collecting layer may include a conductive carbon substrate, metal foil, or metal material with a porous structure. According to embodiments of the disclosure, the metal material with porous structure may have a porosity about 10% to 99.9% (such as about 60% or 70%). In some embodiments, the negative electrode current-collecting layer may include carbon cloth, carbon felt, carbon paper, copper foil, nickel foil, aluminum foil, nickel mesh, copper mesh, molybdenum mesh, nickel foam, copper foam, or molybdenum foam, but the present disclosure is not limited thereto.

In some embodiments, the negative electrode 10 may be obtained by forming a coating on the surface of the negative electrode current-collecting layer through a coating process with the aforementioned negative electrode slurry, and then the coating is subjected to a drying process (the process temperature may be 50° C. to 180° C.). In some embodiments, the coating process may include screen printing, spin coating, bar coating, blade coating, roller coating, solvent casting, dip coating, or any combination thereof, but the present disclosure is not limited thereto.

In some embodiments, the positive electrode 20 may include a positive electrode active layer. The positive electrode active layer may include a positive electrode active material. In some embodiments, the positive electrode active material may include sulfur, organic sulfide, sulfur-carbon composite, metal-containing lithium oxide, metal-containing lithium sulfide, metal-containing lithium selenide, metal-containing lithium telluride, metal-containing lithium phosphide, metal-containing lithium silicide, metal-containing lithium boride, or any combination thereof. In some embodiments, the metal in “metal-containing lithium oxide”, “metal-containing lithium sulfide”, “metal-containing lithium selenide”, “metal-containing lithium telluride”, “metal-containing lithium phosphide”, “metal-containing lithium silicide”, and “metal-containing lithium boride” is selected from at least one of a group consisting of aluminum, vanadium, titanium, chromium, copper, molybdenum, niobium, iron, nickel, cobalt, and manganese. In some embodiments, the positive electrode active material may include lithium-cobalt oxide (LCO), lithium-nickel oxide (LNO), lithium-manganese oxide (LMO), lithium-nickel-cobalt oxide (LNCO), lithium-nickel-manganese oxide (LNMO), lithium-nickel-manganese-cobalt (NMC), lithium-nickel-cobalt-aluminum (NCA), lithium-iron phosphate (LFP), lithium-manganese-iron phosphate (LMFP), or any combination thereof.

In some embodiments, the positive electrode active layer may be prepared from a positive electrode slurry. The positive electrode slurry may include the aforementioned positive electrode active material, conductive additive, binder, and solvent. The positive electrode active material, conductive additive, and binder are dispersed in the solvent, and the solid content of the positive electrode slurry may be 40 wt % to 80 wt %. In some embodiments, in the positive electrode active layer, based on 100 wt % of the positive electrode slurry, the positive electrode slurry includes about 80 wt % to 99.8 wt % of the positive electrode active material, about 0.1 wt % to 10 wt % of the conductive additive, and about 0.1 wt % to 10 wt % of the binder.

Examples of the aforementioned conductive additive may include carbon black, conductive graphite, carbon nanotube, carbon fiber, graphene, or any combination thereof, but the present disclosure is not limited thereto.

Examples of the aforementioned binder may include polyvinyl alcohol, polytetrafluoroethylene, sodium carboxymethyl cellulose, polyvinylidene fluoride, polystyrene butadiene copolymer, fluorinated rubber, polyurethane, polyvinyl pyrrolidone, poly(ethyl acrylate), polyvinyl chloride, polyacrylonitrile, polybutadiene, polyacrylic acid, or any combination thereof, but the present disclosure is not limited thereto.

Examples of the aforementioned solvent may include N-methyl-2-pyrrolidone (NMP), N,N-dimethylformamide (DMF), N,N-dimethylacetamide (DMAc), pyrrolidone, N-dodecylpyrrolidone, γ-butyrolactone, or any combination thereof, but the present disclosure is not limited thereto.

In some embodiments, the positive electrode 20 may further include a positive electrode current-collecting layer. The positive electrode active layer may be disposed on the positive electrode current-collecting layer. In the embodiment where the lithium battery 100 further includes the separator 30, the positive electrode active layer may be disposed between the separator 30 and the positive electrode current-collecting layer. The positive electrode current-collecting layer may include a conductive carbon substrate, metal foil, or metal material with a porous structure. According to embodiments of the disclosure, the metal material with porous structure may have a porosity about 10% to 99.9% (such as about 60% or 70%). In some embodiments, the positive electrode current-collecting layer may include carbon cloth, carbon felt, carbon paper, copper foil, nickel foil, aluminum foil, nickel mesh, copper mesh, molybdenum mesh, nickel foam, copper foam, or molybdenum foam, but the present disclosure is not limited thereto.

In some embodiments, the positive electrode 20 may be obtained by forming a coating on the surface of the positive electrode current-collecting layer through a coating process with the aforementioned positive electrode slurry, and then the coating is subjected to a drying process (the process temperature may be 90° C. to 180° C.). In some embodiments, the coating process may include screen printing, spin coating, bar coating, blade coating, roller coating, solvent casting, dip coating, or any combination thereof, but the present disclosure is not limited thereto.

The separator 30 may include insulating material. Examples of the insulating material may include polyethylene (PE), polypropylene (PP), polytetrafluoroethylene film, polyamide film, polyvinyl chloride film, polyvinylidene fluoride film, polyaniline film, polyimide film, polyethylene terephthalate, polystyrene (PS), cellulose, or any combination thereof, but the present disclosure is not limited thereto. In some embodiments, the separator 30 may be a multilayer composite structure including PE/PP/PE.

The thickness of the separator 30 may be about 1 m to 1,000 m. When the thickness of the separator 30 is too high, for example, greater than 1,000 m, the energy density of the lithium battery 100 is reduced. When the thickness of the separator 30 is too low, for example, less than 1 m, the mechanical strength of the separator 30 is insufficient, and the risk of short-circuit between the negative electrode 10 and the positive electrode 20 in the lithium battery 100 and the self-discharge phenomenon of the battery are increased, and the cycling stability of the battery is affected. In some embodiments, the thickness of the separator 30 may be about 10 m, 50 m, 100 m, 200 m, 300 m, 400 m, 500 m, 600 m, 700 m, 800 m, or 900 m.

The semi-solid electrolyte 40 may include the electrolyte solidified by the ring-opening polymerization process of the aforementioned electrolyte composition. In other words, the semi-solid electrolyte 40 includes the network polymer formed by the ring-opening polymerization (cross-linking) reaction of the aforementioned non-phosphorus polymer. The characteristics of the electrolyte composition have been described above; therefore, further details are omitted here. In some embodiments, the reaction temperature of the ring-opening polymerization process is about 20° C. to 60° C., such as 20° C. to 55° C., or 20° C. to 45° C.

The semi-solid electrolyte 40 may include a network polymer. In some embodiments, the network polymer may include an oxyethylene ether group and C═O. Both C═O and the oxyethylene ether group are easy to coordinate with the lithium salt in the electrolyte composition, which increases the lithium salt cation-anion pairs (Aggregate, AGG). In some embodiments, the network polymer may have repeating units represented by formula (II):

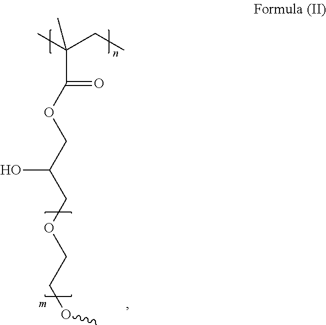

wherein n=30-1200 and m=1-5. In some embodiments, the weight average molecular weight of the network polymer may be greater than or equal to 200,000 g/mol, such as >200,000 g/mol.

By including the aforementioned semi-solid electrolyte 40, the lithium battery of the present disclosure exhibits no leakage, and thus has higher safety. Furthermore, the lithium battery of the present disclosure can significantly reduce the reduction reaction between the lithium negative electrode and the solvent, and easily generate lithium fluoride (LiF, a lithium-philic layer) at the negative electrode, thereby reducing the generation of dendrite and improving the cycle life of the lithium battery. In some embodiments, the battery including the semi-solid electrolyte formed by the electrolyte composition of the present disclosure also has the advantages of high electrochemical stability and/or slow impedance increase.

The following provides specific examples and comparative examples to further illustrate advantages of the electrolyte composition and lithium battery of the present disclosure.

### Preparation Example 1

260 g of glycidyl methacrylate (GMA) monomer and 2.6 g of 2,2′-azobisisobutyronitrile (AIBN) initiator were reacted at 80° C. for 24 hours, and then precipitated and purified to obtain a white powder, thereby obtaining a non-phosphorus polymer with a yield of 77%. Using gel permeation chromatography (GPC) with polystyrene (PS) as the standard, the weight average molecular weight of the non-phosphorus polymer was measured to be about 30,000 g/mol.

### Preparation of Electrolyte Compositions of Examples 1 to 6

### Example 1

1.2 mol of dimethyl ether (DME), 3 mol of 1,1,2,2-tetrafluoroethyl-2,2,3,3-tetrafluoropropyl ether (TTFE), and 1 mol of lithium bis(fluorosulfonyl) imide (LiFSI) were mixed to form Electrolyte 1, and then Electrolyte 1 was mixed with the non-phosphorus polymer of Preparation Example 1 at a weight ratio of 97:2 to form the electrolyte composition of Example 1. The non-phosphorus polymer is insoluble in the Electrolyte 1.

### Example 2

8.8 mol of dimethyl ether (DME), 2.1 mol of 1,1,2,2-tetrafluoroethyl-2,2,3,3-tetrafluoropropyl ether (TTFE), and 1 mol of lithium bis(fluorosulfonyl) imide (LiFSI) were mixed to form Electrolyte 2, and then Electrolyte 2, the non-phosphorus polymer of Preparation Example 1, and lithium tetrafluoroborate as cationic ring-opening polymerization initiator were mixed at a weight ratio of 97:2:1 to form the electrolyte composition of Example 2. After the obtained electrolyte composition was left to stand at room temperature (about 25° C.) for 24 hours, the non-phosphorus polymer precipitated from the electrolyte composition.

### Example 3

8.8 mol of dimethyl ether (DME), 1.7 mol of 1,1,2,2-tetrafluoroethyl-2,2,3,3-tetrafluoropropyl ether (TTFE), and 1 mol of lithium bis(fluorosulfonyl) imide (LiFSI) were mixed to form Electrolyte 3, and then Electrolyte 3, the non-phosphorus polymer of Preparation Example 1, and lithium tetrafluoroborate as cationic ring-opening polymerization initiator were mixed at a weight ratio of 97:2:1 to form the electrolyte composition of Example 3. After the obtained electrolyte composition was left to stand at room temperature for 24 hours, the non-phosphorus polymer precipitated from the electrolyte composition.

### Example 4

8.8 mol of dimethyl ether (DME), 1 mol of 1,1,2,2-tetrafluoroethyl-2,2,3,3-tetrafluoropropyl ether (TTFE), and 1 mol of lithium bis(fluorosulfonyl) imide (LiFSI) were mixed to form Electrolyte 4, and then Electrolyte 4, the non-phosphorus polymer of Preparation Example 1, and lithium tetrafluoroborate as cationic ring-opening polymerization initiator were mixed at a weight ratio of 97:2:1 to form the electrolyte composition of Example 4. After the obtained electrolyte composition was left to stand at room temperature for 24 hours, upon visual observation and touch, the electrolyte composition appears gelled (deforms when touched). Alternatively, the electrolyte composition was then placed in an oven and heated at 55° C. for 60 minutes. It was found to be mostly solidified (with a small amount of liquid separated).

### Example 5

8.8 mol of dimethyl ether (DME), 0.7 mol of 1,1,2,2-tetrafluoroethyl-2,2,3,3-tetrafluoropropyl ether (TTFE), and 1 mol of lithium bis(fluorosulfonyl) imide (LiFSI) were mixed to form Electrolyte 5, and then Electrolyte 5, the non-phosphorus polymer of Preparation Example 1, and lithium tetrafluoroborate as cationic ring-opening polymerization initiator were mixed at a weight ratio of 97:2:1 to form the electrolyte composition of Example 5. After the obtained electrolyte composition was left to stand at room temperature for 24 hours, upon visual observation and touch, the electrolyte composition appears gelled (deforms when touched). Alternatively, the electrolyte composition was then placed in an oven and heated at 55° C. for 60 minutes. It was found to be completely solidified (no liquid separation and no deformation when touched).

### Example 6

13 mol of dimethyl ether (DME), 0.85 mol of 1,1,2,2-tetrafluoroethyl-2,2,3,3-tetrafluoropropyl ether (TTFE), 2 mol of lithium bis(fluorosulfonyl) imide (LiFSI), and 1 mol of lithium bis(trifluoromethanesulfonyl) imide (LiTFSI) were mixed to form Electrolyte 6, and then Electrolyte 6, the non-phosphorus polymer of Preparation Example 1, and lithium tetrafluoroborate as cationic ring-opening polymerization initiator were mixed at a weight ratio of 97:2:1 to form the electrolyte composition of Example 6. After the obtained electrolyte composition was left to stand at room temperature for 24 hours, upon visual observation and touch, the electrolyte composition appears whitish turbidity. Alternatively, the electrolyte composition was then placed in an oven and heated at 55° C. for 60 minutes. It was found to be completely solidified (no liquid separation and no deformation when touched).

As can be seen from Examples 1-6, the lithium salt, solvent and diluent need to be mixed within appropriate ratio range, so that the non-phosphorus polymer can be completely dissolved in the solution and completely solidified at room temperature or after heating. As can be seen from Examples 1-3, the amount used of diluent should not be too high. Although the electrolyte compositions of Examples 5 and 6 can be solidified at room temperature, they exhibit soft texture with poor strength. This shows that when LiFSI is used as lithium salt, if an electrolyte composition that can be solidified at room temperature is to be prepared, the amount used of diluent is expected to be lower, for example, adjusting the molar ratio from 1:0.7 to 1:0.5.

### Preparation of Lithium Metal Batteries

### Example A

The standard lithium metal battery positive electrode slurry (including 97.3 wt % of NMC811 (LiNiᵢMnⱼCoₖO₂, wherein i:0.83-0.85; j:0.4-0.5; and k:0.11-0.12) (with a trade number of NMC811-S85E, manufactured by Ningbo Ronbay New Energy Technology Co., Ltd.), 1 wt % of Super-P (conductive carbon, commercially available from Timcal), 1.4 wt % of PVDF-5130, and 0.3 wt % of carbon nanotube (with a trade number of TUBALL™ BATT, commercially available from OCSiAl), wherein NMC811-S85E, Super-P, PVDF-5130, and carbon nanotube were uniformly dispersed in n-methyl-2-pyrrolidone) was coated on an aluminum foil (serving as the positive electrode current-collecting layer) (commercially available from An Chuan Enterprise Co., Ltd., with a thickness of 12 μm). After drying, a positive electrode was obtained.

A lithium metal-copper foil electrode (including a thin sheet of lithium metal foil attached to a current collector of a copper foil to form the lithium metal-copper foil electrode) was provided as the negative electrode. A separator (with a model number of Celgard 2320, commercially available from Asahi Kasei) was provided.

The negative electrode, the separator, and the positive electrode were arranged in sequence to obtain a lamination and the lamination was encapsulated within an aluminum-plastic film, and then the result was disposed in the oven to dry at 80° C. for 2 hours. The pouch cell that has completed the drying process was taken out, and the electrolyte composition A (including the electrolyte A in Table 1, the non-phosphorus polymer of Preparation Example 1 and lithium tetrafluoroborate at a weight ratio of 97:2:1) was injected into the pouch cell at an argon-filled glovebox. After infiltration, vacuum packaging, and standing for 16 hours, the lithium metal battery of Example A was obtained.

### Example B

According to the battery assembly procedure of Example A, the electrolyte composition B (including the electrolyte B in Table 1, the non-phosphorus polymer of Preparation Example 1 and lithium tetrafluoroborate at a weight ratio of 97:2:1) was injected into the pouch cell to obtain the lithium metal battery of Example B in the same manner as Example A.

### Example C

According to the battery assembly procedure of Example A, the electrolyte composition C (including the electrolyte C in Table 1, the non-phosphorus polymer of Preparation Example 1 and lithium tetrafluoroborate at a weight ratio of 97:2:1) was injected into the pouch cell to obtain the lithium metal battery of Example C in the same manner as Example A.

### Example D

According to the battery assembly procedure of Example A, the electrolyte composition D (including the electrolyte D in Table 1, the non-phosphorus polymer of Preparation Example 1 and lithium tetrafluoroborate at a weight ratio of 97:2:1) was injected into the pouch cell to obtain the lithium metal battery of Example D in the same manner as Example A.

### Comparative Example A

According to the battery assembly procedure of Example A, the electrolyte A in Table 1 was injected into the pouch cell to obtain the lithium metal battery of Comparative Example A in the same manner as Example A.

### Comparative Example B

According to the battery assembly procedure of Example A, the electrolyte B in Table 1 was injected into the pouch cell to obtain the lithium metal battery of Comparative Example B in the same manner as Example B.

### Comparative Example C

According to the battery assembly procedure of Example A, the electrolyte C in Table 1 was injected into the pouch cell to obtain the lithium metal battery of Comparative Example C in the same manner as Example C.

### Comparative Example D

According to the battery assembly procedure of Example A, the electrolyte D in Table 1 was injected into the pouch cell to obtain the lithium metal battery of Comparative Example D in the same manner as Example D.

TABLE 1
Formula of Electrolyte

| | Lithium Salt | | Solvent | | Diluent | |
|---|---|---|---|---|---|---|
| | | content | | content | | content |
| | type | (mol) | type | (mol) | type | (mol) |
| Electrolyte A | LiPF₆ | 1 | FEC | 6.23 | N/A | |
| | | | DMC | 5.56 | | |
| Electrolyte B | LiPF₆ | 1 | FEC | 6.23 | TTFE | 3.3 |
| | | | DMC | 5.56 | | |
| Electrolyte C | LiFSI | 1 | DME | 2.4 | N/A | |
| | LiTFSI | 0.5 | | | | |
| Electrolyte D | LiFSI | 1 | DME | 4.6 | TTFE | 0.5 |
| | LiPF₆ | 0.07 | | | | |

### Example A1

Copper foil (commercially available from Changchun Copper Foil) and lithium foil (commercially available from Honjo Metal, Japan) were used as the positive electrode and the negative electrode, respectively. The positive electrode, the negative electrode, and the separator (commercially available from AsahiKasei, with a model number of Celgard 2320) were arranged in the order of negative electrode/separator/positive electrode to assemble a coin cell. The electrolyte composition A was injected during the assembly, and the coin cell was prepared after sealing. After standing for 16 hours, the copper-lithium half-cell of Example A1 was obtained.

### Example B1

According to the coin cell assembly procedure of Example A1, the electrolyte composition B was injected during the assembly to obtain the copper-lithium half-cell of Example B1 in the same manner as Example A1.

### Example C1

According to the coin cell assembly procedure of Example A1, the electrolyte composition C was injected during the assembly to obtain the copper-lithium half-cell of Example C1 in the same manner as Example A1.

### Example D1

According to the coin cell assembly procedure of Example A1, the electrolyte composition D was injected during the assembly to obtain the copper-lithium half-cell of Example D1 in the same manner as Example A1.

### Comparative Example A1

According to the coin cell assembly procedure of Example A1, the electrolyte A in Table 1 was injected during the assembly to obtain the copper-lithium half-cell of Comparative Example A1 in the same manner as Example A1.

### Comparative Example B1

According to the coin cell assembly procedure of Example A1, the electrolyte B in Table 1 was injected during the assembly to obtain the copper-lithium half-cell of Comparative Example B1 in the same manner as Example A1.

### Comparative Example C1

According to the coin cell assembly procedure of Example A1, the electrolyte C in Table 1 was injected during the assembly to obtain the copper-lithium half-cell of Comparative Example C1 in the same manner as Example A1.

### Comparative Example D1

According to the coin cell assembly procedure of Example A1, the electrolyte D in Table 1 was injected during the assembly to obtain the copper-lithium half-cell of Comparative Example D1 in the same manner as Example A1.

The copper-lithium half-cells of Examples A1 to D1 and Comparative Examples A1 to D1 underwent testing for average Coulombic efficiency. The method used for testing includes: First, perform two activation procedures (negative current 0.5 mA cm⁻² discharging for 10 hours, positive current 0.5 mA cm⁻² with charge cut-off voltage 1V), followed by a test section procedure of discharge (negative current 0.5 mA cm⁻² discharging for 10 hours)→cycle (positive current 0.5 mA cm⁻² for 2 hours; negative current 0.5 mA cm⁻² for 2 hours, and a total of 12 positive-negative cycles)→charge (positive current 0.5 mA cm⁻² with charge cut-off voltage 1V). The test results of the average Coulombic efficiency (C.E._{avg}) of the copper-lithium half-cells of Examples A1 to D1 including semi-solid electrolytes (obtained from the solidified electrolyte compositions A to D) and the copper-lithium half-cells of Comparative Examples A1 to D1 including liquid electrolytes are shown in Table 2 below.

TABLE 2

| | average Coulombic efficiency (C.E._{avg}) |
|---|---|
| Example A1 | 97.6% |
| Comparative Example A1 | 98.8% |
| Example B1 | 99.1% |
| Comparative Example B1 | 98.1% |
| Example C1 | 99.6% |
| Comparative Example C1 | 99.7% |
| Example D1 | 99.1% |
| Comparative Example D1 | 98.8% |

It can be seen from Table 2 that the average Coulombic efficiency can reach more than 99% by using the electrolyte composition containing ether solvents.

### Example A2

Two lithium foils (commercially available from Honjo Metal, Japan) were used as the positive electrode and the negative electrode, respectively. The positive electrode, the negative electrode, and the separator (commercially available from AsahiKasei, with a model number of Celgard 2320) were arranged in the order of negative electrode/separator/positive electrode to assemble a coin cell. The electrolyte composition A was injected during the assembly, and the coin cell was prepared after sealing. After standing for 16 hours, the lithium-lithium half-cell of Example A2 was obtained.

### Example B2

According to the coin cell assembly procedure of Example A2, the electrolyte composition B was injected during assembly to obtain the lithium-lithium half-cell of Example B2 in the same manner as Example A2.

### Example C2

According to the coin cell assembly procedure of Example A2, the electrolyte composition C was injected during assembly to obtain the lithium-lithium half-cell of Example C2 in the same manner as Example A2.

### Example D2

According to the coin cell assembly procedure of Example A2, the electrolyte composition D was injected during assembly to obtain the lithium-lithium half-cell of Example D2 in the same manner as Example A2.

### Comparative Example A2

According to the coin cell assembly procedure of Example A2, the electrolyte A in Table 1 was injected during assembly to obtain the lithium-lithium half-cell of Comparative Example A2 in the same manner as Example A2.

### Comparative Example B2

According to the coin cell assembly procedure of Example A2, the electrolyte B in Table 1 was injected during the assembly to obtain the lithium-lithium half-cell of Comparative Example B2 in the same manner as Example A2.

### Comparative Example C2

According to the coin cell assembly procedure of Example A2, the electrolyte C in Table 1 was injected during the assembly to obtain the lithium-lithium half-cell of Comparative Example C2 in the same manner as Example A2.

### Comparative Example D2

According to the coin cell assembly procedure of Example A2, the electrolyte D in Table 1 was injected during the assembly to obtain the lithium-lithium half-cell of Comparative Example D2 in the same manner as Example A2.

The lithium deposition and stripping performance (deposition and stripping behavior of lithium metal on the electrode body) of the electrolyte composition and electrolyte formulation were tested using lithium-lithium symmetric electrodes. The lithium-lithium half-cells of Examples A2 to D2 and the lithium-lithium half-cells of Comparative Examples A2 to D2 were tested for voltage distributions of five cycles at fixed currents of 0.1 mAcm⁻² and 0.5 mAcm⁻², respectively.

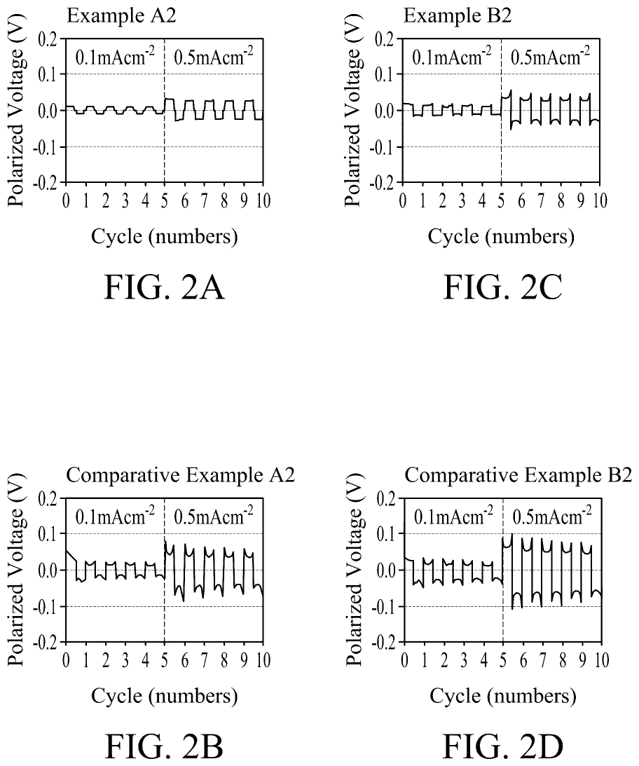

The relationship between polarized voltage and cycles (within 5+5 times) of Examples A2 and B2 and Comparative Examples A2 and B2 are shown in FIGS. 2A to 2D. FIG. 2A is a graph showing the relationship between polarized voltage and cycles of the lithium-lithium half-cell of Example A2. FIG. 2B is a graph showing the relationship between polarized voltage and cycles of the lithium-lithium half-cell of Comparative Example A2. FIG. 2C is a graph showing the relationship between polarized voltage and cycles of the lithium-lithium half-cell of Example B2. FIG. 2D is a graph showing the relationship between polarized voltage and cycles of the lithium-lithium half-cell of Comparative Example B2. By comparing FIG. 2A (Example A2, the electrolyte composition includes the non-phosphorus polymer of Preparation Example 1) and FIG. 2B (Comparative Example A2, the electrolyte composition does not include the non-phosphorus polymer of Preparation Example 1), it can be clearly indicated that the voltage range of lithium deposition and stripping of Example A2 is smaller, and reproducibility of the curves in each of the five cycles is better. Observing FIG. 2C (Example B2, the electrolyte composition includes the non-phosphorus polymer of Preparation Example 1) and FIG. 2D (Comparative Example B2, the electrolyte composition does not include the non-phosphorus polymer of Preparation Example 1) under the same conditions, the voltage range of lithium deposition and stripping of Example B2 is smaller. It can be inferred that the electrolyte composition including the non-phosphorus polymer of Preparation Example 1 can modify the lithium overvoltage range to a better distribution position. It can be seen that the semi-solid electrolyte formed by the electrolyte composition including the non-phosphorus polymer having repeating units represented by formula (I) can optimize the polarized voltage of the lithium metal battery.

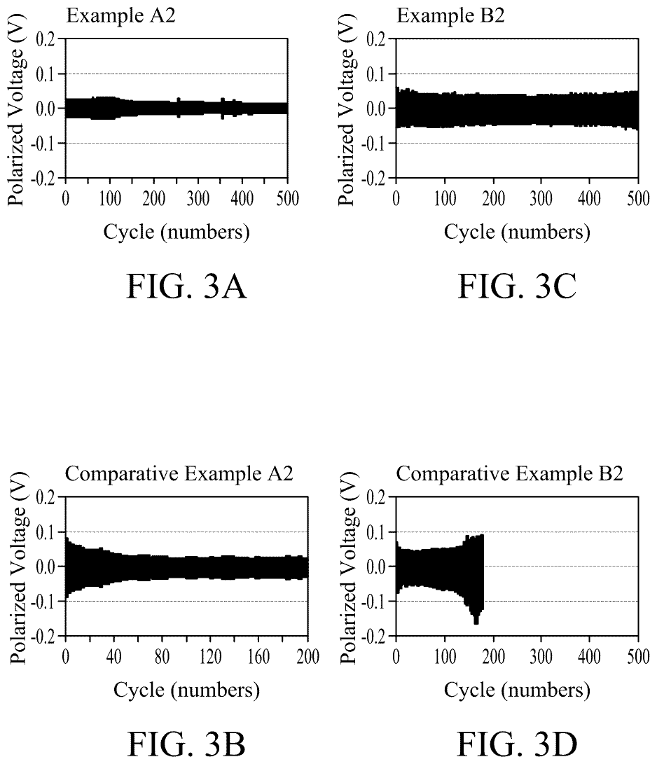

The lithium deposition and stripping performance of the electrolyte and electrolyte formulation were tested using lithium-lithium symmetric electrodes. The lithium-lithium half-cells of Examples A2 to D2 and the lithium-lithium half-cells of Comparative Examples A2 to D2 were tested at a fixed current measurement of 0.5 mAcm⁻² to obtain the relationship between polarized voltage and cycles (five hundred times) of Examples A2 and B2 and Comparative Examples A2 and B2, and the results are shown in FIGS. 3A to 3D. FIG. 3A is a graph showing the relationship between polarized voltage and cycles of the lithium-lithium half-cell of Example A2. FIG. 3B is a graph showing the relationship between polarized voltage and cycles of the lithium-lithium half-cell of Comparative Example A2. FIG. 3C is a graph showing the relationship between polarized voltage and cycles of the lithium-lithium half-cell of Example B2. FIG. 3D is a graph showing the relationship between polarized voltage and cycles of the lithium-lithium half-cell of Comparative Example B2. As can be seen from FIGS. 3A to 3D, the semi-solid electrolyte formed by the electrolyte composition including the non-phosphorus polymer having repeating units represented by formula (I) can reduce the polarized voltage of the lithium metal battery and improve the cycle life of lithium metal battery.

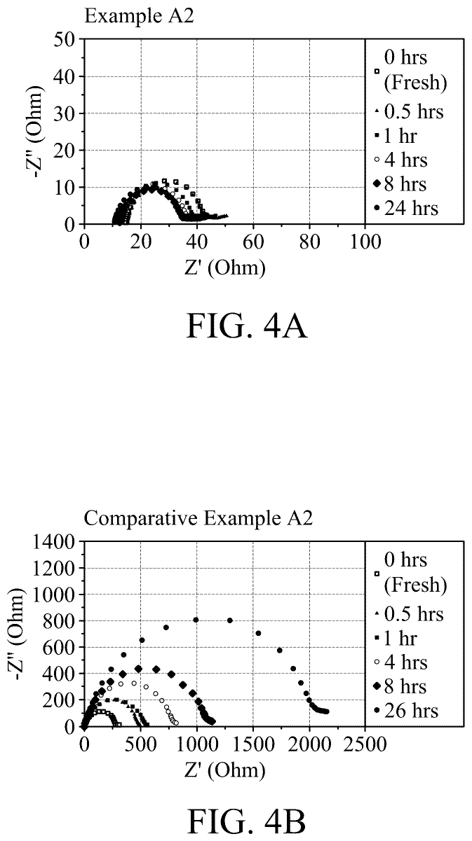

The electrochemical impedance scanning on lithium-lithium symmetric electrodes was performed using a potentiostat. The interfacial resistance generated by the electrode surface layer and charge transfer kinetics that measured at 55° C. changes over time. We performed measurements at 0 hrs, 0.5 hrs, 1 hr, 4 hrs, 8 hrs, and 24 hrs, with measurement frequency of fi=600 kHz to ff=100 mHz, Va=10 mV, and recorded the interface resistance at each time difference. The measurement results of Example A2 and Comparative Example A2 are shown in FIGS. 4A and 4B. FIG. 4A is electrochemical impedance spectroscopy of Example A2. Observing the impedance spectroscopy in each time period, the spacing is small and the positions are concentrated in the parts with smaller impedance. FIG. 4B is electrochemical impedance spectroscopy of Comparative Example A2. The initial resistance is low, but as time goes by, the resistance increases by about 10 times, indicating the instability of the electrolyte. From the distribution of the time periods in FIGS. 4A to 4B, it can be seen that the Z′ of Example A2 is between about 10 and 45 ohm. While the Z′ of Comparative Example A2 is between about 0 and 2000 ohm, which is clearly indicated that the impedance value continues to increase in each time period. It can be seen that adding the semi-solid electrolyte formed by the non-phosphorus polymer having repeating units represented by formula (I) has a smaller impedance increase over time.

### Example D3

Aluminum foil (commercially available from Taiwan Aluminum) and lithium foil (commercially available from Honjo Metal, Japan) were used as the positive electrode and the negative electrode, respectively. The positive electrode, the negative electrode, and the separator (commercially available from AsahiKasei, with a model number of Celgard 2320) were arranged in the order of negative electrode/separator/positive electrode to assemble a coin cell. The electrolyte composition D was injected during the assembly, and the coin cell was prepared after sealing. After standing for 16 hours, the aluminum-lithium half-cell of Example D3 was obtained.

### Comparative Example D3

According to the coin cell assembly procedure of Example D3, the electrolyte D in Table 1 was injected during assembly to obtain the aluminum-lithium half-cell of Comparative Example D3 in the same manner as Example D3.

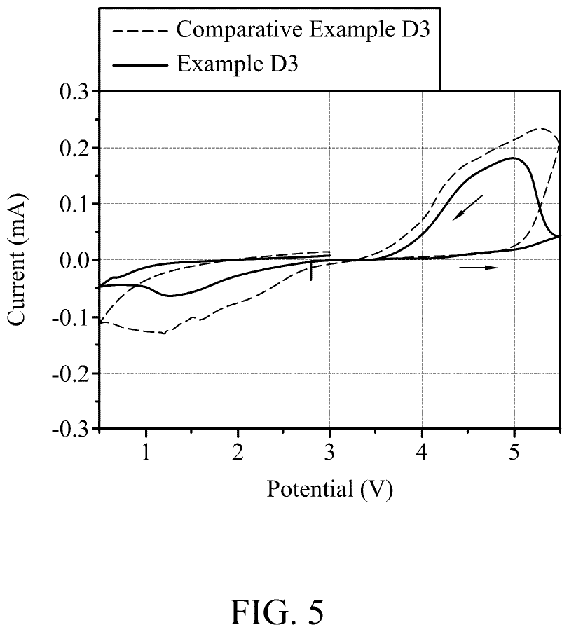

The oxidation-reduction potential scanning test of the electrolyte and electrolyte formulation was carried out using aluminum electrode against lithium electrode. The aluminum-lithium half-cell of Example D3 using the solidifiable electrolyte and the aluminum-lithium half-cell of Comparative Example D3 using the liquid electrolyte were tested, and the results are shown in FIG. 5.

The range of 0.5V to 5.5V was scanned using a potentiostat at a scan rate of 0.2 mV/sec. The relationship between the current and potential of Example D3 and Comparative Example D3 were measured, and the results are shown in FIG. 5. As can be seen from FIG. 5, in the high voltage range of 4.0V to 5.5V, the current value of Example D3 is lower and the enclosed area is smaller, which indicated that the stability performance of Example D3 is better than that of Comparative Example D3 in the high voltage range. As can be seen from FIG. 5, the semi-solid electrolyte formed by the electrolyte composition including the non-phosphorus polymer having repeating units represented by formula (I) can improve the electrochemical stability of the lithium metal battery.

### Comparative Example E

400 g of glycidyl methacrylate (GMA) monomer, 250 g of ethyl phosphate acrylic monomer, and 6.5 g of AIBN initiator were reacted at 80° C. for 24 hours, and then precipitated and purified to obtain a white powder, thereby obtaining a phosphorus-containing polymer with a yield of 78% (as shown below). Using GPC with polystyrene (PS) as the standard, the weight average molecular weight of the phosphorus-containing polymer was measured to be about 35,000 g/mol.

According to the battery assembly procedure of Example A, the electrolyte composition E (electrolyte A in Table 1, the aforementioned phosphorus-containing polymer and lithium tetrafluoroborate at a weight ratio of 96:3:1) was injected into the pouch cell to obtain the lithium metal battery of Comparative Example E in the same manner as Example A.

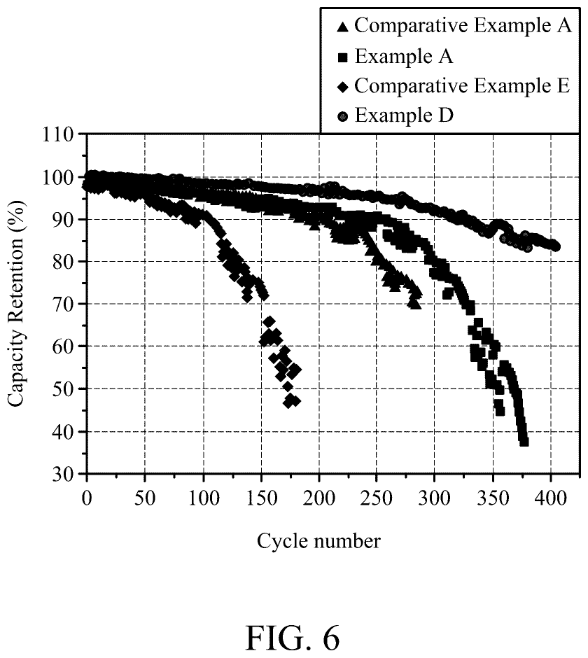

The battery activation and cycle life tests were performed using lithium metal batteries. The cycle life was tested at room temperature with 0.2 C charge/1.0 C discharge cycle at operating voltage range of 4.3V-3.0V. The discharge capacity during the cycle was compared with the discharge capacity of the first cycle to obtain the ratio of capacity of each cycle, which was taken as the capacity retention of each cycle. The relationship between the capacity retention and cycles of the lithium metal batteries of Example A, Example D, Comparative Example A, and Comparative Example E were measured, and the results are shown in FIG. 6. FIG. 6 is a graph showing the relationship between the capacity retention and cycles of the lithium metal batteries of Example A, Example D, Comparative Example A, and Comparative Example E. As shown in FIG. 6, compared with the lithium metal battery of Comparative Example A, the capacity retention of the lithium metal batteries of Examples A and D were merely decrease to 90% of the initial capacity retention after greater cycles. Compared with the lithium metal battery of Comparative Example E, the capacity retention of the lithium metal battery of Comparative Example A was merely decrease to 90% of the initial capacity retention after greater cycles. That is, compared with the lithium metal battery prepared from the electrolyte composition not containing the non-phosphorus polymer, the lithium metal battery prepared from the electrolyte composition containing the non-phosphorus polymer has a longer cycle life. Compared with the lithium metal battery prepared from the electrolyte composition containing the phosphorus-containing polymer, the lithium metal battery prepared from the electrolyte composition not containing non-phosphorus polymer has a longer cycle life.

Accordingly, by including the semi-solid electrolyte formed by solidifying the electrolyte composition of the present disclosure, the lithium metal battery of the present disclosure exhibits no leakage, and has higher safety and/or may have improved cycle life of lithium metal battery.

Although the present embodiments and their advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the present disclosure should be accorded the broadest interpretation so as to encompass all such modifications and similar arrangements.

What is claimed is:

1. An electrolyte composition, comprising:
a solvent;
a lithium salt;
a diluent;
a cationic ring-opening polymerization initiator; and
a non-phosphorus polymer having repeating units represented by formula (I),
wherein based on a total weight of the electrolyte composition being 100 wt %, the electrolyte composition includes 0.5-10 wt % of the non-phosphorus polymer: 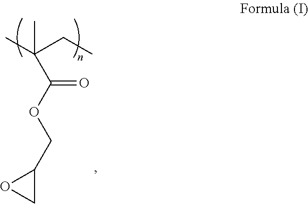
wherein n=30-1200.

2. The electrolyte composition as claimed in claim 1, wherein the diluent is soluble in the solvent but does not coordinate with the lithium salt.

3. The electrolyte composition as claimed in claim 1, wherein a weight average molecular weight of the non-phosphorus polymer is 5,000 to 200,000 g/mol.

4. The electrolyte composition as claimed in claim 1, wherein a molar ratio of the lithium salt to the solvent is 1:2-10.

5. The electrolyte composition as claimed in claim 1, wherein the lithium salt is lithium tetrafluoroborate (LiBF₄), lithium hexafluorophosphate (LiPF₆), lithium perchlorate (LiClO₄), lithium bis(trifluoromethanesulfonyl) imide (LiTFSI), lithium bis(fluorosulfonyl) imide (LiFSI), lithium hexafluoroarsenate (LiAsF₆), lithium hexafluoroantimonate (LiSbF₆), or any combination thereof.

6. The electrolyte composition as claimed in claim 1, wherein the solvent comprises an ether compound.

7. The electrolyte composition as claimed in claim 6, wherein a molar ratio of the lithium salt to the diluent is 1:0.1-0.9.

8. The electrolyte composition as claimed in claim 1, wherein the diluent is an ether compounds different from the solvent.

9. The electrolyte composition as claimed in claim 1, wherein based on the total weight of the electrolyte composition being 100 wt %, the electrolyte composition includes 0.5-5 wt % of the cationic ring-opening polymerization initiator.

10. The electrolyte composition as claimed in claim 1, wherein the cationic ring-opening polymerization initiator is an ionic compound capable of dissociating to release a nucleophilic group or an amine compound.

11. The electrolyte composition as claimed in claim 10, wherein the nucleophilic group comprises: CH₃COO⁻, OH⁻, BF₄⁻, PF₆⁻, ClO₄⁻, TFSI⁻, AsF₆⁻, SbF₆⁻, or any combination thereof.

12. A lithium battery, comprising:
a semi-solid electrolyte;
a positive electrode; and
a negative electrode,
wherein the semi-solid electrolyte is disposed between the positive electrode and the negative electrode,
wherein the semi-solid electrolyte is formed by the electrolyte composition as claimed in claim 1 through a ring-opening polymerization process.

13. The lithium battery as claimed in claim 12, wherein the ring-opening polymerization process comprises a reaction temperature of 20° C. to 60° C.

14. The lithium battery as claimed in claim 12, wherein the semi-solid electrolyte formed by a ring-opening polymerization process of the electrolyte composition comprises a network polymer having a weight average molecular weight greater than or equal to 200,000 g/mol, and having repeating units represented by formula (II): 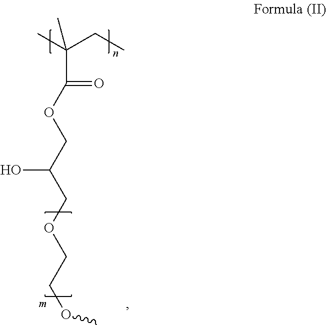
wherein n=30-1200 and m=1-5.

15. The lithium battery as claimed in claim 12, wherein the positive electrode comprises lithium cobalt oxide (LCO), lithium nickel oxide (LNO), lithium manganese oxide (LMO), lithium nickel cobalt oxide (LNCO), lithium nickel manganese oxide (LNMO), lithium nickel manganese cobalt (NMC), lithium nickel cobalt aluminum (NCA), lithium iron phosphate (LFP), lithium manganese iron phosphate (LMFP), or any combination thereof.

16. The lithium battery as claimed in claim 12, wherein the negative electrode comprises lithium metal and alloys thereof, artificial graphite, natural graphite, mesophase carbon microbead, silicon, silicon oxide, carbon-modified silicon oxide, lithium titanium oxide, niobium titanium oxide, or any combination thereof.

17. The lithium battery as claimed in claim 12, further comprising:
a separator disposed between the positive electrode and the negative electrode.

18. The lithium battery as claimed in claim 17, wherein the separator comprises polyethylene (PE), polypropylene (PP), polytetrafluoroethylene film, polyamide film, polyvinyl chloride film, polyvinylidene fluoride film, polyaniline film, polyimide film, polyethylene terephthalate, polystyrene (PS), cellulose, or any combination thereof.
